(19) United States
(12) Patent Application Publication
(10) Pub. No.: US 2026/0058123 A1
(43) Pub. Date: Feb. 26, 2026

(54) CURRENT COLLECTOR WITH MULTIPLE ACTIVE MATERIALS

(71) Applicant: Apple Inc., Cupertino, CA (US)

(72) Inventors: Pedro A. Hernandez Gallegos, Pleasanton, CA (US); Aswin Karthik Manohar, Fremont, CA (US); Shabab Amiruddin, Pacifica, CA (US)

(73) Assignee: Apple Inc., Cupertino, CA (US)

(21) Appl. No.: 19/269,643

(22) Filed: Jul. 15, 2025

Related U.S. Application Data
(60) Provisional application No. 63/686,623, filed on Aug. 23, 2024.

(51) Int. Cl. H01M 4/139; H01M 4/04; H01M 4/70; H01M 10/0525; H01M 10/0585

(52) U.S. Cl. CPC H01M 4/139; H01M 4/0404; H01M 4/70; H01M 10/0525; H01M 10/0585

(57) ABSTRACT

A battery comprising at least one current collector including a first surface and a second surface opposite the first surface, where the at least one current collector is characterized by a longitudinal body section and a lateral body section extending from the longitudinal body section, a first active material positioned on the first surface on the longitudinal body section, and a second active material positioned on the first surface on the lateral body section.

### CROSS-REFERENCES TO RELATED APPLICATIONS

This application claims priority under 35 U.S.C. § 119 (e) to U.S. Provisional Application Ser. No. 63/686,623, filed Aug. 23, 2024, entitled “CURRENT COLLECTOR WITH MULTIPLE ACTIVE MATERIALS,” which is incorporated herein by reference in its entirety.

### BACKGROUND

As electronic devices develop in functionality, there is a commensurate demand to decrease the size of the electronic devices. At the same time, there is a demand for the electronic device to maintain a certain level of battery performance. However, the performance of the electronic device may be limited by the shape and size of the battery.

### BRIEF SUMMARY

One aspect of the disclosure provides for a battery comprising at least one current collector including a first surface and a second surface opposite the first surface, where the at least one current collector is characterized by a longitudinal body section and a lateral body section extending from the longitudinal body section, a first active material positioned on the first surface on the longitudinal body section, and a second active material positioned on the first surface on the lateral body section.

Implementations may include one or more of the following features. The first active material and the second active material may interface against each other. The first active material may be directed to a high-energy storage battery function and the second active material may be directed to a fast-charging battery function. The at least one current collector may be monolithic. The first active material and the second active material may include a different thickness. A gap may be defined between the separator and the second active material. The battery further may include a second separator positioned in the gap. The lateral body section may extend from the longitudinal body section such that the at least one current collector may include an L-shape. A plurality of tabs may extend from the lateral body section. The lateral body section and the longitudinal body section may have different surface areas. The lateral body section and the longitudinal body section may have a substantially similar surface area.

Another aspect of the disclosure provides for a battery comprising a first current collector having a first surface with a first surface are, a first active material positioned on the first surface, a second current collector having a second surface with a second surface area different than the first surface area, where the second current collector is positioned on the first current collector, a second active material positioned on the second surface.

Implementations may include one or more of the following features. A first lateral edge of the first current collector and a second lateral edge of the second current collector may be terminally aligned. The first active material may be directed to a high-energy storage battery function and the second active material may be directed to a fast-charging battery function, and the first surface area is greater than the second surface area. The first current collector and the second current collector may define a space therebetween. The first current collector may include a first set of tabs and the second current collector may include a second set of tabs aligned with the first set of tabs. The battery further may include a separator positioned between the first current collector and the second current collector. The battery may include a first set of electrodes and a second set of electrodes positioned on the first set of electrodes, the first set of electrodes may include a plurality of first current collectors and the second set of electrodes may include a plurality of second current collectors, the first current collector is a current collector of the plurality of first current collectors and the second current collector is a current collector of the plurality of second current collectors, and each current collector of the plurality of first current collectors may include the first surface area and each current collector of the plurality of second current collectors may include the second surface area.

Yet another aspect of the disclosure provides for a method of forming a battery comprising providing a current collector substrate, depositing a first active material and a second active material on a same surface of the current collector substrate, and cutting out a current collector from the current collector substrate, where the current collector may include a longitudinal body section including the first active material and a lateral body section include the second active material.

Implementations may include one or more of the following features. The method where the lateral body section and the longitudinal body section have different surface areas.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A depicts a simplified isometric view of an example battery according to an embodiment of the disclosure.

FIG. 1B depicts a cross-sectional view of the battery of FIG. 1A along Section A-A according to an embodiment of the disclosure.

FIG. 2 depicts a cross-sectional view of a battery according to an embodiment of the disclosure.

FIG. 3 depicts a cross-sectional view of a battery according to an embodiment of the disclosure.

FIG. 4A depicts a simplified isometric view of an example battery according to an embodiment of the disclosure.

FIG. 4B depicts a cross-sectional view of the battery of FIG. 4A along Section B-B according to an embodiment of the disclosure.

FIG. 5A depicts a simplified isometric view of a battery formation system according to an embodiment of the disclosure.

FIG. 5B depicts a simplified isometric view of the battery formation system of FIG. 3A after cutting out a current collector according to an embodiment of the disclosure.

FIG. 6 depicts a flowchart for forming a battery according to an embodiment of the disclosure.

FIG. 7 depicts a block diagram of an example computer system usable with systems and methods according to embodiments of the present disclosure.

### DETAILED DESCRIPTION

Conventional batteries may be designed to provide multiple battery functions, such as both a fast-charge and a high-energy storage. To provide both of these battery functions, conventional batteries may include a dedicated electrode stack for each battery function such that one electrode stack a provides fast-charge capability and the other electrode stack provides a high-energy capability. The fast-charge electrode stack provides faster charging speeds while not being able to store as much energy as a high-energy electrode stack while the high-energy electrode stack provides higher energy storage capacity but does not charge as fast as the fast-charge electrode stack. However, providing two separate electrode stacks may decrease the volumetric energy density of the battery due to the space provide between each of the separate electrode stacks. As such, it is desirable to design a battery to provide multiple battery functions while increasing the volumetric energy density of the battery.

The present disclosure addresses this issue by providing a battery having multiple active materials on a surface of a current collector. In particular, the battery may include a longitudinal body section and a lateral body section extending from the longitudinal body section. A first active material can be positioned on the longitudinal body section and a second active material can be positioned on the lateral body section. Each active material may be directed toward a different battery function, such as a fast-charge and a high-energy storage. Additionally, each active material may interface with each other on the current collector such that there is no space between each active material on the current collector. In this manner, the battery of the present disclosure may include a battery cell that provides multiple battery functions while increasing the volumetric energy density of the battery.

Although the remaining portions of the description may routinely reference lithium-ion battery cells, it will be readily understood by the skilled artisan that the technology is not so limited. The present designs may be employed with any number of battery or energy storage devices, including other rechargeable and primary, or non-rechargeable, cell types, as well as electrochemical capacitors also known as supercapacitors or ultracapacitors, electrolysers, fuel cells, and other electrochemical devices. Moreover, the present technology may be applicable to battery cells and energy storage devices used in any number of technologies that may include, without limitation, phones and mobile devices, handheld electronic devices, wearable devices, laptops and other computers, appliances, heavy machinery, transportation equipment, spacecraft electronics payloads, vehicles, as well as any other device that may use battery cells or benefit from the discussed designs. Accordingly, the disclosure and claims are not to be considered limited to any particular example discussed, but can be utilized broadly with any number of devices that may exhibit some or all of the electrical or chemical characteristics of the discussed examples.

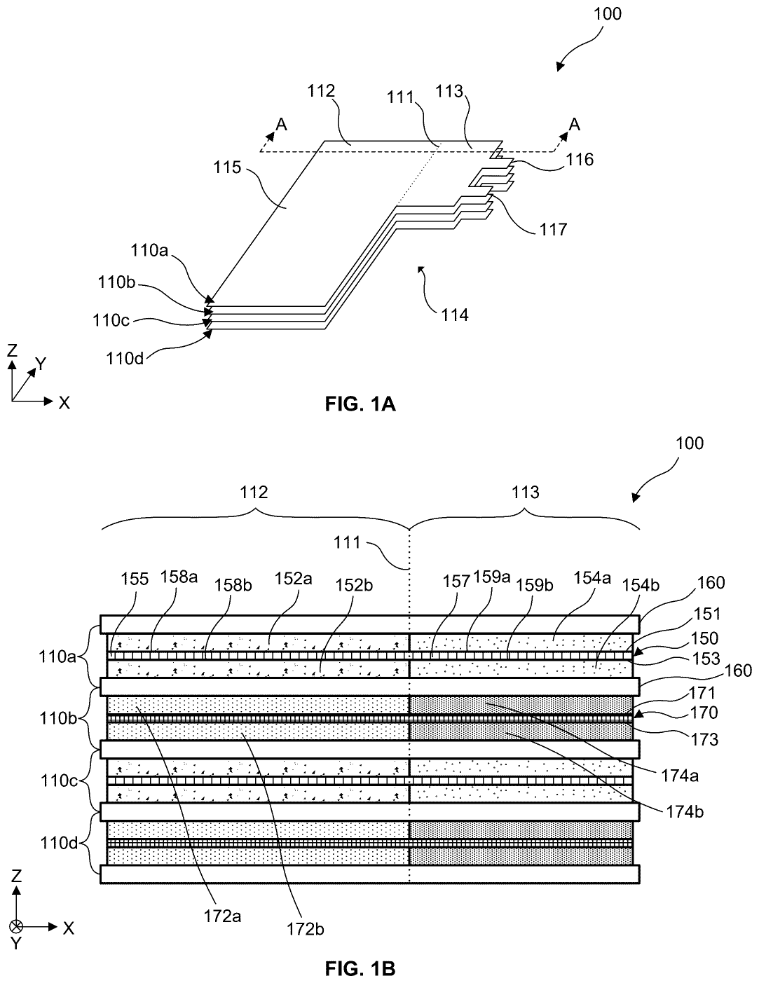

FIGS. 1A and 1B depict a battery 100. The battery 100 may include a first electrode 110a, a second electrode 110b, a third electrode 110c, and a fourth electrode 110d. As will be discussed below, the electrodes 110a, 110b, 110c, 110d may include one or more of a current collector, active materials positioned on the current collector, or a separator. The current collectors of each electrode 110a, 110b, 110c, 110d may be a cathode or anode positioned in alternating sequence (e.g., the first electrode 110a may include a cathode current collector, the second electrode 110b may include an anode current collector, etc., or vice versa). Although only four electrodes 110a, 110b, 110c, 110d are depicted, in other embodiments, the electrode may have more or less than four electrodes, such as one, two, three, five, six, or the like. Although not shown, the electrodes 110a, 110b, 110c, 110d may be positioned in a housing enclosing the electrodes 110a, 110b, 110c, 110d. As would be readily understood, the layers are not shown at any particular scale, and are intended merely to show the possible layers of cell material of one or more cells that may be incorporated into an energy storage device. Each of the electrodes 110a, 110b, 110c, 110d may include a similar configuration but may have different material or chemical compositions. For example, the first electrode 110a may be similar to the third electrode 110c and the second electrode 110b may be similar to the fourth electrode 110d. However, in other embodiments, any of the electrode may be similar or different to any of the other electrodes. As such, unless noted otherwise, only the first electrode 110a will be discussed for the sake of brevity and the description for the first electrode 110a applies to the other electrodes 110b, 110c, 110d.

The first electrode 110a may have a non-rectangular configuration. The first electrode 110a, and the components of the electrode 110a (e.g., the current collectors, separators, or the like, as will be described below) may include a longitudinal body section 112 and a lateral body section 113 extending from the longitudinal body section 112. The longitudinal body section 112 may include a greater surface area than the lateral body section 113. For example, the lateral body section 113 may include a smaller width along the X-direction and a smaller length along the Y-direction than the longitudinal body section 112. However, in other embodiments, the body sections may have a substantially similar surface area, substantially similar dimensions, or the like. For example, e.g., the surface area and/or dimensions of each of the body sections may be within about a 20% deviation of each other, such as about a 10% deviation, such as about a 5% deviation, or being completely the same as each other.

The sections 112, 113 may be delineated by the dotted line 111, provided for visual reference only. The sections 112, 113 may define the first electrode 110a to have a non-rectangular configuration, such as an L-shaped configuration. However, in other embodiments, the first electrode may have any geometric configuration, such as a rectangular configuration, circular configuration, or the like. Although each of the electrodes 110a, 110b, 110c, 110d includes a similar configuration, in other embodiments, two or more of the electrodes can have a different configuration (e.g., rectangular, circular, or the like). The sections 112, 113 may extend substantially normal to each other, such as between about 70° and 110° of each other, such as between about 80° and 100°, or 90°. However, in other embodiments, the sections may extend at any angle relative to each other, including greater than 110° or less than 70°. This configuration may be beneficial because, when the battery 100 is assembled in an electronic device, the sections 112, 113 may define a space 114 to accommodate other components. Further, as will be discussed below, each of the sections 112, 113 may include a different active material.

The first electrode 110a may have a main body section 115 defined by the sections 112, 113. A first tab 116 and a second tab 117 may extend from the main body section 115 (e.g., the current collector of the main body section 115). In particular, the tabs 116, 117 may extend from the lateral body section 113. However, in other embodiments, the tabs may extend from the longitudinal section. In a yet further embodiment, one tab may extend from each of the longitudinal and lateral sections. In an even further embodiment, each of the longitudinal and lateral body sections may have multiple tabs corresponding extending therefrom. As will be discussed further below, it may be beneficial for the tabs 116, 117 to extend from certain sections 112, 113 (e.g., the lateral body section 113) based on the active material positioned on that section 112, 113. In some embodiments, the first tabs 116 of each of the electrodes 110a, 110b, 110c, 110d may be coupled together such that a first current can be drawn from all the first tabs 116 of each of the electrodes 110a, 110b, 110c, 110d at once and the second tabs 117 of each of the electrodes 110a, 110b, 110c, 110d may be coupled together such that a second current can be drawn from all of the second tabs 117 of each of the electrodes 110a, 110b, 110c, 110d at once. However, in other embodiments, the first tabs and second tabs of each of the electrodes may not be correspondingly coupled together.

As noted above, it may be beneficial for each the electrodes 110a, 110b, 110c, 110d to include multiple active materials along a same current collector such that each current collector can provide multiple battery functions (e.g., fast-charge, high-energy storage, or the like). Whereas conventional batteries that provide these multiple battery functions using multiple electrode stacks, the battery 100 may provide these multiple battery functions with a single electrode stack, thus minimizing the space occupied by the battery 100 and increasing the volumetric energy density of the battery 100.

Turning to FIG. 1B, the battery 100 is depicted along Section A-A. In particular, the first electrode 110a may include a first current collector 150 having a first longitudinal section 155 (corresponding to the longitudinal body section 112) and a second lateral section 157 (corresponding to the lateral body section 113) extending from the longitudinal section 155 at the dotted line 111. The first longitudinal section 155 may include a first longitudinal surface 158a and a second longitudinal surface 158b. The first lateral section 157a may include a first lateral surface 159a and a second lateral surface 159b. The first longitudinal surface 158a and the first lateral surface 159a may, collectively, define a first surface 151 of the first current collector 150. The second longitudinal surface 158b and the second lateral surface 159b may, collectively, define a second surface 153 of the first current collector 150. The first current collector 150 may be monolithic such that the sections 155, 157 are a single piece integrally formed together. However, in other embodiments, each of the longitudinal and lateral sections may not be integrally formed and, instead, may be separate pieces positioned against each other such that there is no space between each of the sections. The first longitudinal surface 158a and the first lateral surface 159a, and the second longitudinal surface 158b and the second lateral surface 159b, may be co-planar. However, in other embodiments, the first longitudinal and lateral surfaces, and the second longitudinal and lateral surfaces, may correspondingly not be co-planar and, instead, may be angled and/or offset along the Z-axis from each other.

Each of the surfaces 151, 153 may include multiple active materials positioned thereon. For example, the first electrode 110a may include a first active material 152a, a second active material 152b, a third active material 154a, and a fourth active material 154b. The first active material 152a and the third active material 154a may be positioned on the first surface 151, and the second active material 152b and the fourth active material 154b may be positioned on the second surface 153. As will be discussed below, the active materials 152a, 152b may be a first type of active material including a similar first composition (e.g., a similar chemical or material composition, porosity, impedance gradience, chemical coating, chemical treatment, thickness, or the like) directed to a first battery function and the active materials 154a, 154b may be a second type of active material including a similar second composition directed to a second battery function different than the first battery function. Although each surface 151, 153 may include a corresponding two active materials 152a, 152b, 154a, 154b, in other embodiments, each surface may include more than two active materials, such as three, four, five, or the like. Additionally, although each surface 151, 153 may correspondingly include a same number of active materials 152a, 152b, 154a, 154b, in other embodiments, each surface may include a different number of active materials than another surface. In a yet further embodiment, active material may be deposited only on one surface of the first current collector (e.g., the first or second surface) while the other surface may be free of active material.

The first active material 152a may be positioned on the first longitudinal surface 158a and the second active material 152b may be positioned on the second longitudinal surface 158b. The third active material 154a may be positioned on the first lateral surface 159a and the fourth active material 154b may be positioned on the second lateral surface 159b. In this manner, the active materials 152a, 152b and the active materials 154a, 154b may be correspondingly aligned along the Z-axis by battery function. However, in other embodiments each of the active materials may not be aligned by battery function. For example, in other embodiments, the active material positioned on each of the surfaces of the longitudinal and lateral body sections in the Z-direction may be a different type of active material. In one example, the first active material may be positioned on the first longitudinal surface and the fourth active material may be positioned on the second longitudinal surface while the third active material may be positioned on the first lateral surface and the second active material may be positioned on the second lateral surface. This alternating stack of types of active materials may provide different properties to the battery, such as changing the longevity of the battery or the like. In a yet further embodiment, the active materials may be positioned on the lateral and longitudinal surfaces in any other combination. Although one active material 152a, 152b, 154a, 154b is correspondingly positioned on the longitudinal surfaces 158a, 158b and lateral surfaces 159a, 159b, in other embodiments, each of the longitudinal and lateral surfaces may include multiple active materials positioned thereon.

The first active material 152a and the second active material 152b may share a first composition, and the third active material 154a and the fourth active material 154b may share a second composition. The first composition may be directed to a first battery function while the second composition may be directed to a second battery function different than the first battery function. For example, the first battery function may be directed to a high-energy storage function and the second battery function may be directed to a fast-charge function. In other words, the first composition of the active materials 152a, 152b can store greater amounts of energy than second composition of the active materials 154a, 154b but can have a slower current transfer rate than the active materials 154a, 154b. In other embodiments, there may be other battery functions other than high-energy storage and fast-charge. In this manner, the first electrode 110a may provide multiple battery functions corresponding to each of the active materials 152a, 152b, 154a, 154b.

Each of the types of active material may have a difference impedance characteristic such that, during use, one or more of the types of active materials may be more active depending on the current that is being drawn from the tabs 116, 117. For example, a first current may be drawn from the first tab 116 of the first electrode 110a to activate active materials 152a, 152b and a second current may be drawn from the second tab 117 of the first electrode 110a to activate active materials 154a, 154b. In this manner, each of the tabs 116, 117 of the first electrode 110a may correspond to the type of active material of the active materials 152a, 152b, 154a, 154b positioned on the first electrode 110a. The tabs 116, 117 of the other electrodes 110b, 110c, 110d may similarly correspond to the type of active material positioned on the electrodes 110b, 110c, 110d. In other embodiments, the tabs may not correspond to the type of active material positioned on the first electrode. For example, in some embodiments, the first electrode may include only a single tab that can activate the desired type of active material depending on the current drawn from that tab.

The active materials 152a, 154a may be positioned on the first surface 151 of the first current collector 150 such that the active materials 152a, 154a interface against each other. The active materials 152b, 154b may be positioned on the second surface 152 of the first current collector 150 such that the active materials 152b, 154b against each other. In other words, there may be no space between the active materials 152a, 154a such that the active materials 152a, 154a abuts against each other on the first surface 151 and between the active materials 152b, 154b such that the active materials 152b, 154b against each other on the second surface 152. In this manner, the first electrode 110a may provide multiple battery functions while also requiring less space compared to conventional batteries that used multiple electrode stacks spaced from each other in order to provide multiple battery functions.

It may be further beneficial to position certain of the active materials 152a, 152b, 154a, 154b on certain portions of the first current collector 150 based on a distance from the tabs 116, 117. For example, it may be beneficial to position the active materials 154a, 154b on the lateral section 157 closer to the tabs 116, 117 based on the battery function of the active materials 154a, 154b. In particular, if the active materials 154a, 154b has a higher current transfer rate (e.g., due to providing a fast-charge battery function) and is the active material where the most current flow in and out of for the first electrode 110a, it may be beneficial to position the active materials 154a, 154b closer to the tabs 116, 117 such that the distance the current has to travel from the active materials 154a, 154b may be decreased to provide the faster charge. However, in other embodiments, the active materials directed to fast-charging may not be positioned close to the tabs and, instead, active material directed to other functions (e.g., high-energy storage or the like) may be positioned closer to the tabs.

As noted above, in other embodiments, each of the first longitudinal section and first lateral section may include one or more tabs extending therefrom. For example, each of the longitudinal and lateral sections can have a dedicated tab (or tabs) extending therefrom to optimize the current transfer of each of the types of active materials. In this manner, the active materials having a first composition can transfer current to a first tab (or tabs) extending from the first longitudinal section and the active materials having a second composition can transfer current to a second tab (or tabs) extending from the first lateral section. Accordingly, the sections of the current collector may include a tab (or tabs) extending therefrom corresponding to the type of active material positioned on that section. In this example, the tab(s) from one of the longitudinal or lateral sections may extend in a direction opposite or transverse to the tab(s) from the other section.

In some embodiments, it may be beneficial to position certain of the active materials 152a, 152b, 154a, 154b on certain portions of the first current collector 150 based on a surface area of the sections 155, 157. For example, where the active materials 154a, 154b are directed to fast-charging and the active materials 152a, 152b are directed to high-energy storage, the first electrode 110a may require more of the active materials 152a, 152b than the active materials 154a, 154b (e.g., to increase the amount of energy storage available to the active materials 152a, 152b). As such, it may be beneficial to position the active materials 154a, 154b on the lateral section 157 and the active materials 152a, 152b on the longitudinal section 155 since the lateral section 157 has a smaller surface area than the longitudinal section 155. Accordingly, the size and configuration of the first current collector 150 may be adjusted according to the desired quantity and position of the active materials 152a, 152b, 154a, 154b based on the battery function of the active materials 152a, 152b, 154a, 154b. In other embodiments, the active materials directed to high-energy storage may be positioned on the longitudinal section and the active materials directed to fast-charging may be positioned on the lateral section. In yet other embodiments, the active materials may be positioned on the lateral and longitudinal sections of the current collector irrespective of the battery function of the active materials.

The material of the first current collector 150 may be a material selected based on the potential of the active materials 152a, 152b, 154a, 154b positioned on the first current collector 150. In other words, the material of the first current collector 150 may be selected based on the electrochemical compatibility of the first current collector 150 with the active materials 152a, 152b, 154a, 154b positioned on the first current collector 150. For example, the first current collector 150 may include a metal material (e.g., copper, stainless steel, aluminum, or other suitable metal materials) or a non-metal material (e.g., a polymer or composite that may include a conductive material).

The active materials 152a, 152b, 154a, 154b may be any suitable battery materials operable in rechargeable or non-rechargeable battery designs. In some embodiments, the active materials 152a, 152b, 154a, 154b may include an anode active material, however, in other embodiments, the active materials of the first current collector may include a cathode active material. For example, where one or more of the active materials 152a, 152b, 154a, 154b include an anode active material, those active materials 152a, 152b, 154a, 154b may include silicon, graphite, carbon, a tin alloy, lithium metal, a lithium-containing material, such as lithium titanium oxide (LTO), or other suitable materials that can form an anode in a battery cell. Where one or more of the active materials 152a, 152b, 154a, 154b include a cathode active material, those active materials 152a, 152b, 154a, 154b may include a lithium-containing material such as a lithium metal oxide, which can include lithium cobalt oxide, lithium manganese oxide, lithium nickel manganese cobalt oxide, lithium nickel cobalt aluminum oxide, lithium titanate, a lithium iron phosphate, or other suitable materials that can form a cathode in a battery cell.

The active materials 152a, 152b, 154a, 154b may additionally include an amount of electrolyte in a completed cell configuration. The electrolyte may be a liquid including one or more salt compounds that have been dissolved in one or more solvents. The salt compounds may include lithium-containing salt compounds in embodiments, and may include one or more lithium salts including, for example, lithium compounds incorporating one or more halogen elements such as fluorine or chlorine, as well as other non-metal elements such as phosphorus, and semimetal elements including boron, for example. In some embodiments, the salts may include any lithium-containing material that may be soluble in organic solvents. The solvents included with the lithium-containing salt may be organic solvents, and may include one or more carbonates. For example, the solvents may include one or more carbonates including propylene carbonate, ethylene carbonate, ethyl methyl carbonate, dimethyl carbonate, diethyl carbonate, and fluoroethylene carbonate. Combinations of solvents may be included, and may include for example, propylene carbonate and ethyl methyl carbonate as an exemplary combination. Any other solvent may be included that may enable dissolving the lithium-containing salt or salts as well as other electrolyte component, for example, or may provide useful ionic conductivities.

The active materials 152a, 152b, 154a, 154b and the first current collector 150 may be positioned between separators 160. The separator 160 may include a polymer film or a material that may allow lithium ions to pass through the structure while not otherwise conducting electricity. In other embodiments, the battery may include less separators than as shown or no separators.

The second electrode 110b may include a fifth active material 172a, a sixth active material 172b, a seventh active material 174a, and an eighth active material 174b. The active materials 172a, 174a may be positioned on a third surface 171 of the second current collector 170 and the active materials 172b, 174b may be positioned on a fourth surface 173 of the second current collector 170. The active materials 172a, 172b may be a third type of active material that has a different composition than the active materials 152a, 152b of the first electrode 110a but may still be directed to a similar battery function (e.g., high-energy storage) as the active materials 152a, 152b. Similarly, the active materials 174a, 174b may be a fourth type of active material that has a different composition than the active materials 154a, 154b of the first electrode 110a but may also be directed to a similar battery function (e.g., fast-charge) as the active materials 154a, 154b. The different compositions of active materials 152a, 152b, 154a, 154b and the first current collector 150 of the first electrode 110a, and the active materials 172a, 172b, 174a, 174b and the second current collector 170 of the first electrode 110b may correspond with whether the electrodes 110a, 110b are a cathode or anode. For example, where the first electrode 110a is an anode electrode, the active materials 152a, 152b, 154a, 154b may include a composition directed to an anode active material while, where the second electrode 110b is a cathode electrode, the active materials 172a, 172b, 174a, 174b may include a composition directed to a cathode active material. The tabs 116, 117 of the second electrode 110b may activate the active materials 172a, 172b, 174a, 174b based on the current drawn from the corresponding tabs 116, 117 as described above for the first electrode 110a. Although the electrodes 110a, 110b depict active materials 152a, 152b, 154a, 154b, 172a, 172b, 174a, 174b on both of the respective surfaces 151, 153, 171, 173 of the current collectors 150, 170, in other embodiments, the electrodes may have active materials on only one side of the current collectors. In some examples, the first electrode 110a may be similar to the third electrode 110c and the second electrode 110b may be similar to the fourth electrode 110d. Accordingly, the third electrode 110c may also be an anode electrode and the fourth electrode 110d may also be a cathode electrode. However, in other embodiments, the first and third electrodes may be cathode electrodes while the second and fourth electrodes may be anode electrodes.

Although the layers of each of the electrodes 110a, 110b, 110c, 110d may be shown formed in a cell structure with stacked sheets, the layers may also be formed into a jelly roll design, folded design, prismatic design, or any form such that any number of layers may be included in battery 100. One or more tabs 116, 117 may be coupled together (e.g., all of the first tabs 116 of each electrode 110a, 110b, 110c, 110d, all of the second tabs 117 of each electrode 110a, 110b, 110c, 110, all the tabs 116, 117 of the cathode current collector, all the tabs 116, 117 of the anode current collector, or the like). Once the electrodes 110a, 110b, 110c, 110d are formed into a cell structure, a pouch, housing, or other enclosure may be formed about the cell to contain electrolyte and other materials within the cell structure to form the battery 100. The housing may conform to a shape of the stacked electrodes 110a, 110b, 110c, 110d (e.g., have a non-rectangular geometry). However, in other embodiments, the housing may not conform to the shape of the electrodes and, instead, may have any other shape. Terminals may extend from the enclosure to allow electrical coupling of the cell for use in devices, including an anode and cathode terminal. The coupling may be directly connected with a load that may utilize the power, and in some embodiments the battery 100 may be coupled with a control module that may monitor and control charging and discharging of the battery cell. The battery 100 is an exemplary cell that may be incorporated in battery systems according to the present technology. It is to be understood, however, that any number of battery and battery cell designs and materials that may include charging and discharging capabilities similarly may be encompassed by the present technology.

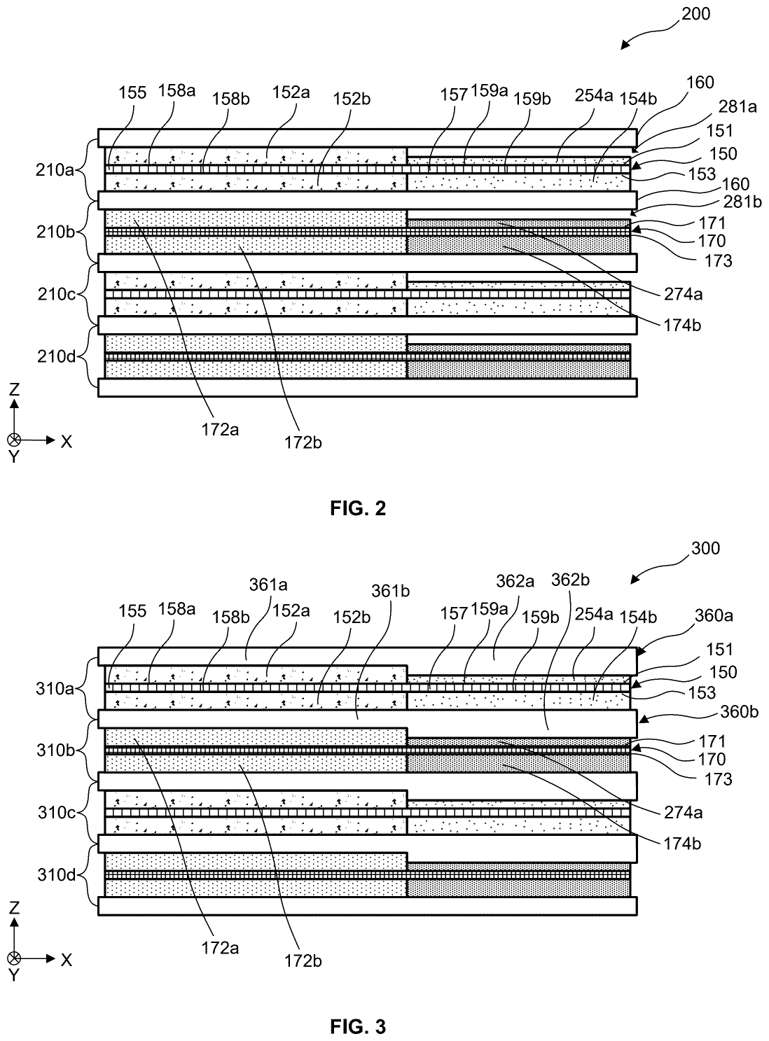

As noted above, in other embodiments, one or more of the active materials may have a different thickness. For example, FIG. 2 depicts an example battery 200. It is understood that features ending in like reference numerals as features discussed above are similar, except as noted below. The third active material 254a and the seventh active material 274a may have a correspondingly smaller thickness along the Z-direction than the active materials 154b, 174b such that the third active material 254a and the adjacent separator 160 defines a first gap 281a and the seventh active material 274a and the adjacent separator 160 defines a second gap 281b. The gaps 281a, 281b may be beneficial to optimize the performance of the battery 200 based on the types of active materials 152a, 172a, 254a, 274a. For example, where the active materials 152a, 172a are very different in composition compared to the active materials 254a, 274a (e.g., where one set of either the first set of the active materials 152a, 172a or the second set of the active materials 254a, 274a includes a silicon material, or the like), this imbalance in the Z-direction may be beneficial to enhance the performance of the battery 200.

However, in some embodiments, if unaccounted for, the difference in thickness of the active materials 152a, 172a, 254a, 274a may decrease the structural integrity of the battery 200 and may lead to a variance in height along the Z-direction across the X-Y plane for each of the electrodes 210a, 210b, 210c, 210d, which can adversely affect the performance of the battery 200. As such, it may be beneficial to position a material in the gaps 281a, 281b to increase the structural integrity of the battery 200 and to ensure that each electrode 210a, 210b, 210c, 210d of the battery cell includes a similar thickness. For example, in other embodiments, additional separators may be positioned in the gaps to ensure that each electrode can have a similarly consistent height.

In a yet further embodiment, a monolithic separator can accommodate this difference in thicknesses of the active material while also separating adjacent active materials of adjacent electrodes. For example, FIG. 3 depicts an example battery 300. It is understood that features ending in like reference numerals as features discussed above are similar, except as noted below. The battery 300 includes a first separator 360a and a second separator 360b. The first separator 360a may include a first portion 361a and a second portion 362a. The first portion 361a may have a first thickness that is less than a second thickness 362a. The second separator 360b may include a third portion 361b and a fourth portion 362b. The third portion 361b may have a third thickness that is less than a fourth thickness of the fourth portion 362b. The difference in thicknesses of the portions 361a, 362a, 361b, 362b may account for the difference in thickness of the active materials 152a, 172a, 254a, 274a. In particular, the first portion 361a may be positioned on the thicker first active material 152a while the second portion 362a may be positioned on the thinner third active material 254a. The third portion 362b may be positioned on the thicker fifth active material 172a while the fourth portion 362b may be positioned on the thinner seventh active material 274a. In this manner, the electrodes 310a, 310b, 310c, 310d may be stacked together such that each electrode 310a, 310b, 310c, 310d includes a similar height and the battery 300 may have an increased structural integrity. In some embodiments, the separators 360a, 360b can be made of a pliable material such that, when compressed against the corresponding active materials 152a, 172a, 254a, 274a, the separators 360a, 360b can conform to the shape of the active materials 152a, 172a, 254a, 274a. However, in other embodiments, the separators may be a rigid material that is shaped to account for the difference in the thicknesses of the active material below the separators.

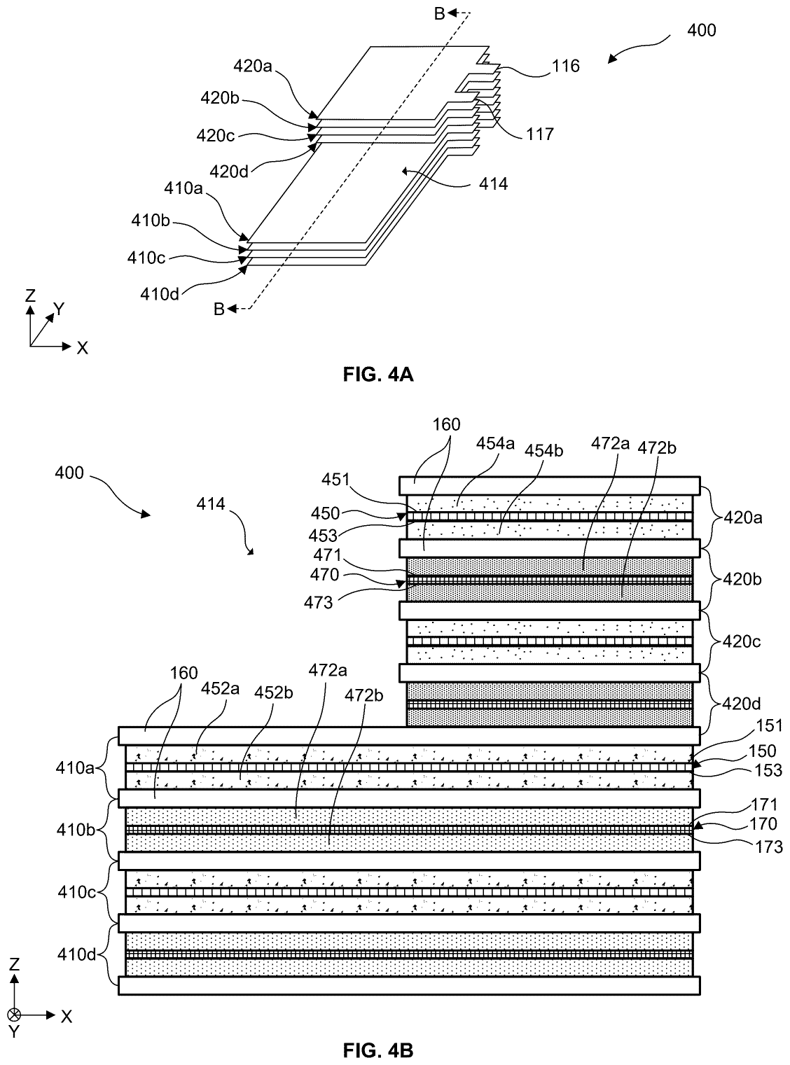

However, in some embodiments, having multiple active materials on each current collector may decrease battery life from the uneven current distribution along each electrode during use. As such, in other embodiments, the electrodes may not include multiple active materials on a single current collector but, instead, may include a single active material on each current collector that is stacked together in different sets based on the type of active material of each electrode. For example, FIGS. 4A and 4B depict a battery 400. It is understood that features ending in like reference numerals as features discussed above are similar, except as noted below. The battery 400 may include a first electrode 410a, a second electrode 410b, a third electrode 410c, a fourth electrode 410d, a fifth electrode 420a, a sixth electrode 420b, a seventh electrode 420c, and an eight electrode 420d. The first electrode 410a may be similar to the third electrode 410c, the second electrode 410b may be similar to the fourth electrode 410d, the fifth electrode 420a may be similar to the seventh electrode 420c, and the sixth electrode 420b may be similar to the eighth electrode 420d. The electrodes 410a, 410c, 420a, 420c may be anode electrodes while the electrodes 410b, 410d, 420b, 420d may be cathode electrodes, or vice versa.

Each of the electrodes 410a, 410b, 410c, 410d, 420a, 420b, 420c, 420d may include a single current collector with a single type of active material positioned thereon. For example, turning to FIG. 4B, which depicts a cross-sectional view of the battery 400 of FIG. 4A along Section B-B, the first electrode 410a may include a first active material 452a positioned on the first surface 151 of the first current collector 150 and a second active material 452b positioned on the second surface 153 of the first current collector 150. The second electrode 410b may include a third active material 472a positioned on the third surface 171 of the second current collector 170 and a fourth active material 472b on the fourth surface 173 of the second current collector 170. The fifth electrode 420a may include a fifth active material 454a positioned on a fifth surface 451 of a third current collector 450 and a sixth active material 454b on a sixth surface 453 of the third current collector 450. The sixth electrode 420b may include a seventh active material 472a positioned on a seventh surface 471 of a fourth current collector 470 and an eight active material 472b on an eighth surface 473 of the fourth current collector 470. The current collectors 150, 450 may include a similar composition and the current collectors 170, 470 may include a similar composition. However, in other embodiments, the first current collector and the third collector may have a different composition, and the second current collector and fourth current collector may have a different composition. The active materials 454a, 454b and third current collector 450, and the active materials 472a, 472b and fourth current collector 470, may be positioned between separators 460 that are similar to the separators 160 in composition. In other embodiments, the battery may include less separators than as shown or no separators.

The electrodes 410a, 410b, 410c, 410d, 420a, 420b, 420c, 420d may be positioned relative to each other such that the tabs 116, 117 of each of the electrodes 410a, 410b, 410c, 410d, 420a, 420b, 420c, 420d are correspondingly aligned along the Z-direction. This may allow the tabs 116, 117 of the electrodes 410a, 410b, 410c, 410d, 420a, 420b, 420c, 420d to be grouped together and for current to be more easily drawn from all the electrodes 410a, 410b, 410c, 410d, 420a, 420b, 420c, 420d. However, in other embodiments, at least some of the tabs from some of the electrodes may not be aligned with other tabs of other electrodes.

The active materials 452a, 452b, 472a, 472b of the electrodes 410a, 410b may be directed to a first battery function (e.g., high-energy storage) while the active materials 454a, 454b, 474a, 474b of the electrodes 420a, 420b may be directed to a second battery function (e.g., fast-charge). In use, each of the active materials 452a, 452b, 454a, 454b, 472a, 472b, 474a, 474b may be activated based on the current drawn from the tabs 116, 117, as described above. In this manner, the battery 400 may be able to provide multiple battery functions in one electrode stack rather than multiple electrode stacks of conventional batteries. The battery 400 may offer the additional benefit of increasing battery life compared to batteries with multiple active material on each current collector (e.g., batteries 100, 200, 300, as shown in FIGS. 1A-3) by minimizing the uneven degradation of electrodes caused by the uneven current distribution that can arise from the use of multiple active materials on each current collector of each electrode. Accordingly, the battery 400 may provide an increased volumetric energy density and battery life.

The surface area of the current collectors 150, 170 and the current collectors 450, 470 may be different corresponding to a desired quantity of the respective active materials 452a, 452b, 454a, 454b, 472a, 472b, 474a, 474b based on a battery function of active material of the 452a, 452b, 454a, 454b, 472a, 472b, 474a, 474b. For example, the active materials 452a, 452b, 472a, 472b may require a larger amount than an amount of the active materials 454a, 454b, 474a, 474b because a larger quantity for the first battery function of the active materials 452a, 452b, 472a, 472b (e.g., high-energy storage) is desired for optimal performance than a quantity for the second battery function of the active materials 454a, 454b, 474a, 474b (e.g., fast-charge). As such, the active materials 452a, 452b, 472a, 472b may be positioned on the current collectors 150, 170 having a larger surface area and the active materials 454a, 454b, 474a, 474b may be positioned on the current collectors 450, 470 having a smaller surface area. However, in other embodiments, the active materials may be positioned on the current collectors irrespective of the battery function of the active materials. In a yet further embodiment, the battery may include a battery cell (e.g., an electrode stack) with electrodes that have a different surface area and that also each include multiple active materials on each current collector.

Although the electrodes 410a, 410b, 420a, 420b, depict active materials 452a, 452b, 454a, 454b, 472a, 472b, 474a, 474b on both of the respective surfaces 151, 153, 171, 173, 451, 453, 471, 473 of the current collectors 150, 170, 450, 470, in other embodiments, the electrodes may have an active material on only one side of the current collectors. Additionally, although the electrodes 410a, 410b, 410c, 410d, and electrodes 420a, 420b, 420c, 420d are depicted as including a similar width along the X-direction and a dissimilar length along the Y-direction, in other embodiments, the electrodes may have other lengths and widths. For example, the first, second, third, and fourth electrodes may include a larger length and width than the fifth, sixth, seventh, and eighth electrodes. In another example, the first, second, third, and fourth electrodes may include a similar length along the Y-direction and a dissimilar width along the X-direction.

The first electrode 410a and the electrodes 420a, 420b, 420c, 420d may define a space 414 to accommodate other components. In particular, the lateral edges of the electrodes 410a, 410b, 410c, 410d along the Y-direction and the lateral edges of the electrodes 420a, 420b, 420c, 420d may all be aligned together along the Z-direction, and the first electrode 410a and the electrodes 420a, 420b, 420c, 420d may have a different surface area, such that the space 114 is defined between the first electrode 410a and the electrodes 420a, 420b, 420c, 420d. By aligning the lateral edges of the electrodes 410a, 410b, 410c, 410d, 420a, 420b, 420c, 420d in this manner, the size of the space 414 can be maximized. However, in other embodiments, the fifth, sixth, seventh, and eighth electrodes can be positioned on an intermediate portion of the first electrode such that multiple spaces are defined between the first electrode, and the fifth, sixth, seventh and eighth electrodes.

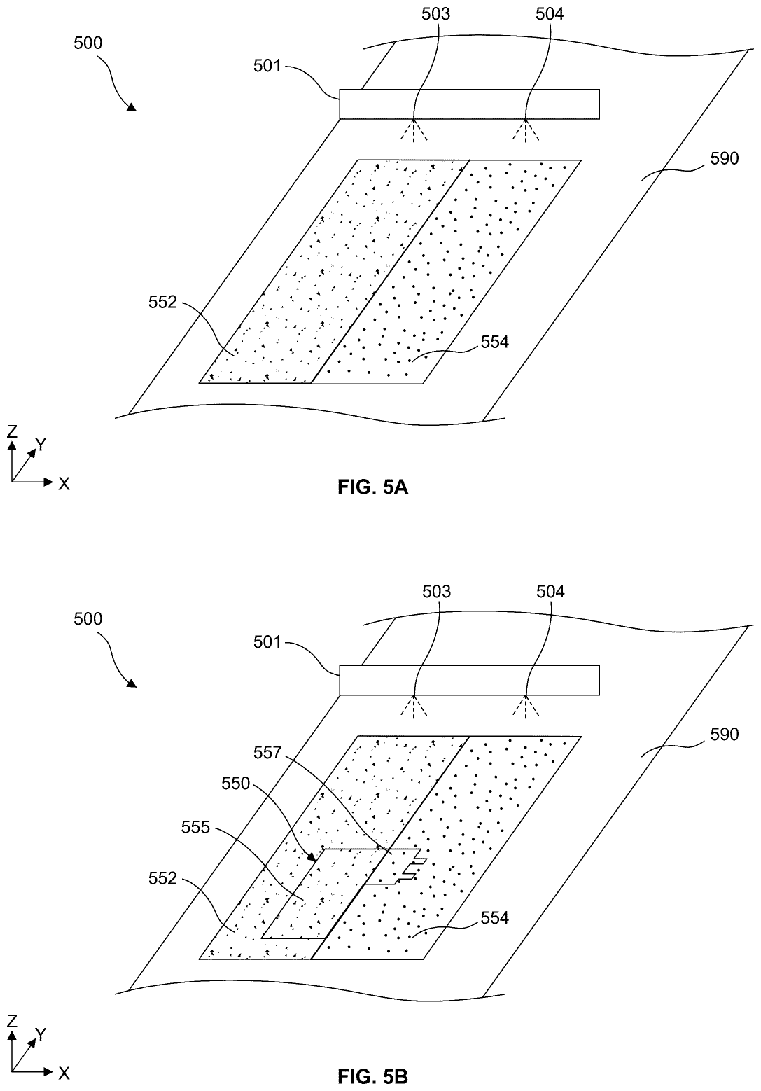

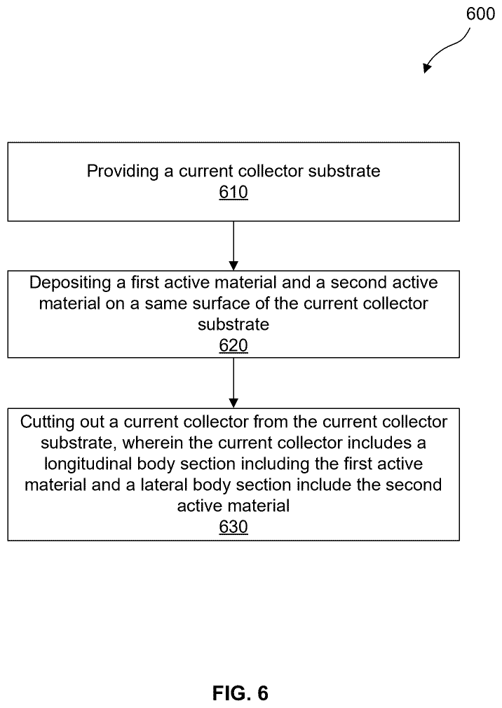

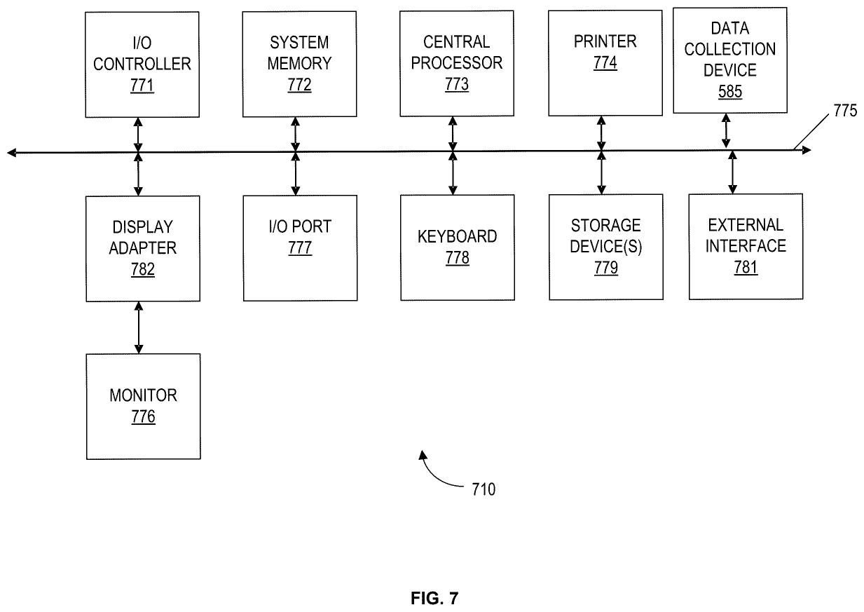

FIGS. 5A and 5B depict an example battery formation system 500 for use in forming a battery. FIG. 6 depicts an example flowchart showing a process 600 for using the battery formation system 500. It is understood that features ending in like reference numerals as features discussed above are similar, except as noted below. The below process can be performed by a computer system, such as the computer system 710 depicted in FIG. 7.

Block 610 includes providing a current collector substrate. For example, turning to FIG. 5A, the battery formation system 300 may include a belt system 302 transporting a current collector substrate 590 in a machine direction (e.g., a Y-direction). The current collector substrate 390 may include a metal or non-metal material similar to the current collector materials described above. In some embodiments, the current collector substrate 390 may be provided with active materials on a bottom surface of the current collector substrate 390 (e.g., on an opposite surface of the current collector substrate 390 than shown in FIG. 5A).

Block 620 may include depositing a first active material and a second active material on a same surface of the current collector substrate. For example, remaining on FIG. 5A, the battery formation system 500 may include a coating device 501 that deposits a first active material 552 and a second active material 554 on a same surface of the current collector substrate 590. For example, the coating device 501 may include a first nozzle 503 that can spray or flow the first active material 552 on the current collector substrate 590 and a second nozzle 504 that can spray or flow the second active material 554 on a same surface (e.g., the top surface) of the current collector substrate 590. The active material 552, 554 may be deposited such that the active material 552, 554 interface with each other. In embodiments where more than two active materials are desired on each current collector, the coating device may include a corresponding number of nozzles to deposit the corresponding number of active materials on the current collector substrate.

Block 630 may include cutting out a current collector from the current collector substrate, wherein the current collector includes a longitudinal body section including the first active material and a lateral body section include the second active material. For example, turning to FIG. 5B, a cutting mechanism (not shown) may cut out a current collector 550 from the current collector substrate 590 (e.g., via punching or the like). Specifically, the cutting mechanism may cut through both the active materials 552, 554 and the current collector substrate 590 to form the current collector 550. The current collector 550 may include a longitudinal section 555 with the first active material 552 and a lateral section 557 with the second active material 554. In some embodiments, where the current collector substrate was provided with active material on a bottom side of the current collector substrate, cutting the current collector may include through active material on both sides of the current collector such that the current collector is formed with active material on both sides of the current collector (e.g., similar to the first current collector 150, as shown in FIG. 1B).

Once the current collector 550 is formed, the battery formation system 500 may include additional processing steps. For example, the battery formation system 500 may include rollers (not shown) to roll the active materials 552, 554 on the current collector 550 to a desired thickness and density. In some embodiments, there may be individual rollers for each of the active materials such that each active material can be rolled to a particular thickness and density. However, in other embodiments, there may be no other processing steps after the current collector is cut out. The current collector 550 can then be stacked with other layers (e.g., other current collectors, separators, or the like) to form a battery cell that is stacked, in a jelly roll design, folded design, prismatic design, or the like. Once the battery cell is formed, the battery formation system 500 may form an enclosure (e.g., a pouch, housing, or the like) about the battery cell and electrolyte injected into the enclosure to contain electrolyte and other materials within the cell structure to form a battery.

Any of the computer systems mentioned herein may utilize any suitable number of subsystems. Examples of such subsystems are shown in FIG. 7 in computer system 710. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 7 are interconnected via a system bus 775. Additional subsystems such as a printer 774, keyboard 778, storage device(s) 779, monitor 776 (e.g., a display screen, such as an LED), which is coupled to display adapter 782, and others are shown. Peripherals and input/output (I/O) devices, which couple to I/O controller 771, can be connected to the computer system by any number of means known in the art such as input/output (I/O) port 777 (e.g., USB, Fire Wire®). For example, I/O port 777 or external interface 781 (e.g., Ethernet, Wi-Fi, etc.) can be used to connect computer system 710 to a wide area network such as the Internet, a mouse input device, or a scanner. The interconnection via system bus 775 allows the central processor 773 to communicate with each subsystem and to control the execution of a plurality of instructions from system memory 772 or the storage device(s) 779 (e.g., a fixed disk, such as a hard drive, or optical disk), as well as the exchange of information between subsystems. The system memory 772 and/or the storage device(s) 779 may embody a computer readable medium. Another subsystem is a data collection device 785, such as a camera, microphone, accelerometer, and the like. Any of the data mentioned herein can be output from one component to another component and can be output to the user.

A computer system can include a plurality of the same components or subsystems, e.g., connected together by external interface 781, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components.

Aspects of embodiments can be implemented in the form of control logic using hardware circuitry (e.g., an application specific integrated circuit or field programmable gate array) and/or using computer software stored in a memory with a generally programmable processor in a modular or integrated manner, and thus a processor can include memory storing software instructions that configure hardware circuitry, as well as an FPGA with configuration instructions or an ASIC. As used herein, a processor can include a single-core processor, multi-core processor on a same integrated chip, or multiple processing units on a single circuit board or networked, as well as dedicated hardware. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium such as a compact disk (CD) or DVD (digital versatile disk) or Blu-ray disk, flash memory, and the like. The computer readable medium may be any combination of such devices. In addition, the order of operations may be re-arranged. A process can be terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Such programs may also be encoded and transmitted using carrier signals adapted for transmission via wired, optical, and/or wireless networks conforming to a variety of protocols, including the Internet. As such, a computer readable medium may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Any operations performed with a processor (e.g., aligning, determining, comparing, computing, calculating) may be performed in real-time. The term “real-time” may refer to computing operations or processes that are completed within a certain time constraint. The time constraint may be 1 minute, 1 hour, 1 day, or 7 days. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom” or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used.

Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In some implementations, operations or processing may involve physical manipulation of physical quantities. Typically, although not necessarily, such quantities may take the form of electrical or magnetic signals capable of being stored, transferred, combined, compared, or otherwise manipulated. It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as apparent from the discussion herein, it is appreciated that throughout this specification discussions utilizing terms such as “processing,” “computing,” “calculating,” “determining,” or the like refer to actions or processes of a specific apparatus, such as a special purpose computer, special purpose computing apparatus or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

What is claimed is:

1. A battery comprising:
at least one current collector including a first surface and a second surface opposite the first surface, wherein the at least one current collector is characterized by a longitudinal body section and a lateral body section extending from the longitudinal body section;
a first active material positioned on the first surface on the longitudinal body section; and
a second active material positioned on the first surface on the lateral body section.

2. The battery of claim 1, wherein the first active material and the second active material interfaces against each other.

3. The battery of claim 1, wherein the first active material is directed to a high-energy storage battery function and the second active material is directed to a fast-charging battery function.

4. The battery of claim 1, wherein the at least one current collector is monolithic.

5. The battery of claim 1, wherein the first active material and the second active material includes a different thickness.

6. The battery of claim 5, further comprising a first separator, wherein a gap is defined between the separator and the second active material.

7. The battery of claim 6, further comprising a second separator positioned in the gap.

8. The battery of claim 1, wherein the lateral body section extends from the longitudinal body section such that the at least one current collector includes an L-shape.

9. The battery of claim 1, wherein a plurality of tabs extend from the lateral body section.

10. The battery of claim 1, wherein the lateral body section and the longitudinal body section have different surface areas.

11. The battery of claim 1, wherein the lateral body section and the longitudinal body section have a substantially similar surface area.

12. A battery comprising:
a first current collector having a first surface with a first surface area;
a first active material positioned on the first surface;
a second current collector having a second surface with a second surface area different than the first surface area, wherein the second current collector is positioned on the first current collector; and
a second active material positioned on the second surface.

13. The battery of claim 12, wherein a first lateral edge of the first current collector and a second lateral edge of the second current collector are terminally aligned.

14. The battery of claim 12, wherein:
the first active material is directed to a high-energy storage battery function and the second active material is directed to a fast-charging battery function; and
the first surface area is greater than the second surface area.

15. The battery of claim 12, wherein the first current collector and the second current collector defines a space therebetween.

16. The battery of claim 12, wherein the first current collector includes a first set of tabs and the second current collector includes a second set of tabs aligned with the first set of tabs.

17. The battery of claim 12, further comprising a separator positioned between the first current collector and the second current collector.

18. The battery of claim 12, wherein:
the battery includes a first set of electrodes and a second set of electrodes positioned on the first set of electrodes;
the first set of electrodes includes a plurality of first current collectors and the second set of electrodes includes a plurality of second current collectors;
the first current collector is a current collector of the plurality of first current collectors and the second current collector is a current collector of the plurality of second current collectors; and
each current collector of the plurality of first current collectors includes the first surface area and each current collector of the plurality of second current collectors includes the second surface area.

19. A method of forming a battery comprising:
providing a current collector substrate;
depositing a first active material and a second active material on a same surface of the current collector substrate; and
cutting out a current collector from the current collector substrate, wherein the current collector includes a longitudinal body section including the first active material and a lateral body section include the second active material.

20. The method of claim 19, wherein the lateral body section and the longitudinal body section have different surface areas.
